(19) United States
(12) Patent Application Publication
(10) Pub. No.: US 2007/0031582 A1
(43) Pub. Date: Feb. 8, 2007

(54) Oxigen stable active containing compositions

(76) Inventors: Jack Burger, Lelystad (NL); Fabio Campanile, Amsterdam (NL); Louis Doorn, Zeewolde (NL); Frans Witteveen, Leusden (NL); Pino Corda, Huizen (NL)

Correspondence Address: FITCH, EVEN, TABIN & FLANNERY, P. O. BOX 18415, WASHINGTON, DC, 20036, US

(21) Appl. No.: 10/552,623

(22) PCT Filed: Apr. 8, 2004
(86) PCT No.: PCT/NL04/00231

§ 371 Date: Oct. 7, 2005

(30) Foreign Application Priority Data
Apr. 8, 2003 (EP) 03076038.3
Jan. 16, 2004 (EP) 04075111.7

(51) Int. Cl. A23J 1/00

(52) U.S. Cl. 426/656

(57) ABSTRACT

The invention relates to a moisture and oxygen stable composition comprising inert core particles and a partial or complete coating thereon of at least one active compound encapsulated in a carbohydrate matrix, which matrix is characterised by 5 to 95 wt. % high molecular weight film forming carbohydrate; 5 to 30 wt. % mono, di and trisaccharides; and 0 to 30 wt. % maltodextrin. based on the total weight of the carbohydrate matrix, wherein the coated particle is further coated with a modified cellulose. The active compound to be encapsulated in the carbohydrate matrix can be selected from the group consisting of flavourants, fragrances, pharmaceuticals and wash-active components.

### TECHNICAL FIELD OF THE INVENTION

The present invention relates to oxygen stable active containing compositions and to processes for their manufacture.

### BACKGROUND OF THE INVENTION

Flavours are used as additives in many food and non-food products. Typically, flavours are added to confections, chewing gums, dentifrices, and so forth. Accordingly, incorporation of flavours, in particular of volatile or aromatic flavourants, to foods has been the subject of intensive research within the field of flavour R&D. Typically, such volatile or aromatic flavourants are selected from coffee aroma, mint aroma, esters, acetaldehyde, various essential oils, sulphur compounds, and mixtures thereof.

However, a problem encountered with such flavours is their sensitivity to oxygen especially upon storage, leading to the oxidation of the flavouring components, which in turn can give flavours off-notes. As a result of this oxidation, the consumer's acceptance of such products is diminished.

The application of encapsulating techniques has been employed to protect flavours from such oxidation. Still, there is a desire to provide improved stabilised active containing compositions against oxidation.

The carrier of the flavours is also of importance. The carriers of the prior art usually are too soft to withstand strong mechanical pressures, in particular those occurring upon the chewing gum process conditions. Those chewing gum process conditions typically involve temperatures between 35-55° C., as well as high shear forces caused by mixing in so-called Z-blade mixers. The soft structure, typically resulting from the combined use of a suitable gum base (resins, emulsifiers, PVA, fillers, and elastomers), sugars and sugar syrups (or the sugar free equivalents), glycerol and flavouring, as well as the temperature—shear combination and finally the moisture content of about 1-5%, cause flavour leakage, resulting in a quick loss of the flavours and thus bad perception of the product by the consumers.

Recently, it has been found by the Applicant, as described in WO 02/47492, that a moisture and oxygen stable composition can be obtained by using a composition comprising inert core particles partially or completely coated with at least one active compound encapsulated in a carbohydrate matrix comprising an amount of 5 to 95 wt. % high molecular weight film forming carbohydrate in combination with 5 to 30 wt. % mono, di and/or trisaccharides and 0 to 30 wt. % maltodextrin, based on the total weight of the carbohydrate matrix and brought into the form of a glassy state.

EP-A 1 252 892 describes a coating agent comprising (a) a modified cellulose and (b) at least one of an edible water-soluble additive and an edible polymer substance. The coating agent is said to be particularly effective for coating a core material which should be protected from deterioration caused by vaporization of components, changes in components, color change, discoloration, etc. and preferably can be quickly released in the presence of water.

It was found that the requirement of a sugar free carrier, e.g. in sugar free chewing gum, imposes a restriction on the use of mono and disaccharides, leading to poor oxygen stability. This poor oxygen stability is related to the use of alternative sweeting molecules such as sorbitol, xylitol, or other sweetening agents which cause a considerable lowering of the glass transition temperature of the carrier system.

It was also found that certain products such as chewing gums, are more sensitive to oxygen than other products, especially upon long periods of storage, due to interaction of the base materials with flavour components.

Accordingly, there is a need for an improved oxygen stable active containing composition.

One solution to solve this problem would be to incorporate antioxidants to the composition. However, it is sometimes necessary to add a higher quantity than necessary when the composition is diluted. Further, like many other additives, their use tends to be more and more legislated and the authorised dosages thereby diminished.

Still another approach to solve this problem is to eliminate the critical oxidising compounds from the flavour mix. However, this would dramatically limit the flavour profiles possibilities.

The inventors have unexpectedly found that particles that are extremely stable against oxidation can be obtained by further coating the particles according to WO 02/47492 with a modified cellulose having reversible gel formation properties upon temperature increase. Furthermore, the present composition is capable of withstanding severe processing conditions, notably conditions of high shear, i.e. under such conditions not more than limited leakage of the active compound is observed.

### SUMMARY OF THE INVENTION

In one aspect of the present invention, there is provided an oxygen stable composition comprising inert core particles partially or completely coated with at least one active compound encapsulated in a carbohydrate matrix, which matrix is characterised by.

5 to 95 wt. % high molecular weight film forming carbohydrate;

5 to 30 wt. % mono, di and trisaccharides; and

0 to 30 wt. % maltodextrin

based on the total weight of the carbohydrate matrix;

the coated particles being further coated with a modified cellulose having reversible gel formation properties upon temperature increase.

In another aspect of the present invention, there is provided a process for preparing said composition comprising the steps of
(a) forming an aqueous carbohydrate solution containing a carbohydrate mixture comprising of 5 to 95 wt. % high molecular weight film forming carbohydrate(s), 5 to 30 wt. % mono, di and trisaccharide(s), and 0 to 30 wt. % maltodextrin(s);
(b) incorporating at least one active compound into the solution of step (a);
(c) introducing the aqueous solution of step (b) into a fluid bed comprising inert core particles and using an inlet air temperature of 40-120° C., preferably 60-100° C., to obtain a core particle coated with the active compound encapsulated in a carbohydrate matrix; and
(d) introducing after step (c) the modified cellulose as an aqueous solution with a concentration of 2-30 wt. % and preferably 5-15 wt. % into the fluid bed comprising the encapsulated active coated core particles and using an inlet air temperature of 40-120° C., preferably 60-100° C., to deposit a stable film onto the particles.

In a further aspect of the invention, there are provided products comprising said composition.

In a still further aspect of the invention, there is provided the use of modified cellulose to improve the oxygen stabilisation of one or more active compounds encapsulated in a matrix comprising coating the encapsulate with said modified cellulose.

### DETAILED DESCRIPTION OF THE INVENTION

Inert core particles partially or completely coated with at least one active compound encapsulated in a glassy state carbohydrate matrix are essential elements of the present invention.

By “inert core particles”, it is meant particles which do not react with the coating material and/or the active. The inert core particles can be any particulate material which is inert under the fluidised bed conditions. However, for the sake of convenience, the inert core particles can be selected from edible materials, preferably from the group consisting of vegetable particles like tea fannings, tea dust and tobacco particles, all kinds of crystal products like acids (e.g. citric acid or malic acid, especially citric acid), crystals of mono, di or trisaccharides (e.g. sugar) and salt crystals, further all sorts of fibers like organic and artificial fibers like gum arabic, cellulose cells, maltodextrin, plant seeds like sesame seed, caraway seed etc. and spray-dried flavours.

Citric acid can advantageously be used as inert core particle and is thus one preferred inert core particle for use in the present invention, especially for the preparation of marshmallows. Typically, citric acid is associated with processing drawbacks. For instance, the presence of dissolved acid, such as citric acid, in hot sugar-gelatin mass has a negative influence on the further processing of the composition. The temperature at which proper aeration can take place drops significantly (from 50° C. to 35° C.). As a result, the cooling process becomes longer, more intense and therefore more expensive. In addition, quality aspects like high product stability and low density are often more difficult to meet in case of acid-containing marshmallows.

The present invention provides a remedy to these problems. The use of a modified cellulose coating in the present composition enables the preparation of particles that will withstand processing conditions and will limit the interaction during storage of citric acid with the base material. Thus, in a preferred embodiment, the at least 50 wt. % of the inert core particle is citric acid. More preferably at least 80 wt. % of the core particle is citric acid, most preferably at least 90 wt. % of the core particle is citric acid.

The core particles of the invention typically have a size in the range of 0.1-3 mm, preferably 0.2-1.5 mm. The coating of the inert core particle can be made partial or completely. By “partial”, it is meant that at least 60% of the particle surface is coated. For the purpose of the present invention, the coating is made of at least one active material encapsulated in a carbohydrate matrix. The carbohydrate matrix is characterized by

5 to 95 wt. % high molecular weight film forming carbohydrate;

5 to 30 wt. % mono, di and/or trisaccharides; and

0 to 30 wt. % maltodextrin

based on the total weight of the carbohydrate matrix.

More in particular the carbohydrate matrix includes from 45 to 70 wt. %, preferably from 50 to 60 wt. % high molecular weight film forming carbohydrate. Suitable film forming carbohydrates are film forming gums, pectins, alginates, mucilages and mixtures thereof. Preferably the film forming carbohydrates are selected from gum arabic, gum acacia, tragacanth, karaya, ghatti, agar, alginates, carrageenans, fucellan, psyllium and mixtures thereof or from gelatin, dextran, xanthan, curdlan, cellulose, methylcellulose, ethylcellulose, hydroxyethylcellulose, hydroxypropyl cellulose, hydroxypropyl methylcellulose, carboxymethyl cellulose, low methoxy pectin, propylene glycol alginate and mixtures thereof. Most preferably the film forming agents are film forming gums, hydrocolloids and lipophilically modified starches. Examples of gums are gum arabic and gum acacia. Examples of suitably chemically modified starches are Capsul® and N-Lok (National Starch). Of course, also mixtures of film forming carbohydrates can be used in the compositions according to the invention.

Another component of the carbohydrate matrix according to the invention are the mono, di and trisaccharides, which are used in an amount of 5 to 30 wt. %, preferably 15-25 wt. %, based on the total weight of the carbohydrate matrix. Mustrative examples of mono, di and trisaccharides are glucose, fructose, maltose, sucrose, raffinose, sorbitol, xylitol and materials having a high content of such sugars like fruit juice solids. Preferably, at least 50 wt. % of the mono, di and trisaccharide material is a disaccharide as a high amount of monosaccharide may result in a somewhat sticky product whereas a high amount of trisaccharide may lead to a product more prone to oxidation. In a preferred embodiment according to the invention the mono, di and trisaccharide material is sucrose.

For sugar free applications, e.g. sugar free chewing gum or sugar free beverages, as well as applications in dental products, e.g. toothpaste and mouthwash, it is highly desirable that the present composition does not contain significant amounts of sugar. The use of alternative sweeteners, such as sorbitol, xylitol and other sweetening agents, is known to have a negative impact on oxidation stability, mainly due to the adverse effect on the glass transition temperature of the carrier system. Surprisingly, it was found that the present particulate composition may suitably contain between 1 and 30 wt. % of a sweetener selected from the group consisting of sorbitol, mannitol, xylitol, hydrogenated starch hydrolysates, lactitol, maltitol, erythritol, hydrogenated isomaltulose and combinations thereof. Preferably the amount of sweetener in the composition is at least 5 wt. %, more preferably at least 10 wt. %. Typically, the amount of sweetener does not exceed 25 wt. %, most preferably it does not exceed 20 wt. %. The oxidative stability of the latter compositions is exceptionally good, presumably due to a synergetic combined effect of the carbohydrate matrix and the cellulose coating. More preferably the aforementioned sweetener is a monosaccharide, especially sorbitol, xylitol or a combination thereof.

The carbohydrate matrix according to the invention further includes 0 to 30 wt. %, preferably 10 to 30 wt. % maltodextrin. The maltodextrin will preferably have a dextrose equivalent (DE) in the range of 1 to 25, most preferably in the range of 10 to 20. A variety of maltodextrins meeting the above requirements are readily available commercially, including maltodextrins from e.g. tapioca, maize and potato.

The inventors have found that the stability of the present composition can be enhanced even further by providing the coated inert particles with an additional external coating comprising at least 50 wt. % lipids with a melting point of at least 30° C., preferably of at least 35° C. The term lipids as used in here refers to lipophilic fatty acid residue containing materials such as triglycerides, diglycerides, monoglycerides, phosphatides and sucrose fatty acid polyesters. Most preferably, the lipids employed in the external coating are triglycerides. According to another preferred embodiment the external coating layer contains at least 80 wt. % lipids, more preferably at least 90 wt. % lipids.

The carbohydrate matrix may be softened by the incorporation of up to 5 wt. % of an edible polyol such as glycerol, preferably 1 to 3 wt. %, based on the carbohydrate matrix. Also other components like anti-foam agents in an amount of up to 0.2% may be added.

The active compound to be encapsulated in the carbohydrate matrix can be selected from the group consisting of flavourants, fragrances, pharmaceuticals and wash-active components.

Flavourants are well-known in the art and are mentioned, e.g., in S. Arctander, Perfume and Flavour Materials of Natural Origin (Elisabeth, N.J., USA, 1996), in T. E. Furia et al, CRC Fenaroli's Handbook of Flavour Ingredients, 2nd Ed. (Cleveland, CRC Press Inc., 1975), and in H. B. Heath, Source Book of Flavours (The Avi Publishing Company Inc., Westport, Conn., 1981).

Fragrances and mixtures thereof which can be used for the preparation of perfumed articles are e.g. naturally occurring products such as essential oils, absolutes, resinoids, resins, concretes etc., natural, nature identical and artificial fragrances, such as hydrocarbons, alcohols, aldehydes, ketones, ethers, acids, esters, acetals, ketals, nitriles etc., covering saturated and unsaturated compounds, aliphatic, carbocyclic and heterocyclic compounds, for instance as disclosed in S. Arctander (loc.cit.).

Examples of flavour and/or fragrance ingredients which may be used within the scope of the invention are: geraniol, geranyl acetate, linalool, linalyl acetate, tetrahydrolinalool, citronellol, citronellyl acetate, dihydro myrcenol, dihydro myrcenyl acetate, tetrahydro myrcenol, terpineol, terpinyl acetate, nopol, nopyl acetate, 2-phenylethanol, 2-phenylethyl acetate, benzyl alcohol, benzyl acetate, benzyl salicylate, styrallyl acetate, benzyl benzoate, amyl salicylate, dimethylbenzyl carbinol, trichloromethylphenylcarbinyl acetate, p-tert. butylcyclohexyl acetate, isononyl acetate, vetiveryl acetate, vetiverol, α-hexyl-cinnamaldehyde, 2-methyl-3-(p-tert.butylphenyle)-propanal, 2-methyl-3-(p-isopropyl phenyl)-propanal, 3-(p-tert.butylphenyl)-propanal, tricyclodecenyl acetate, tricyclo-decenyl propionate, 4-(4-hydroxy-4-methylpentyl)-3-cyclohexene carbaldehyde, 4-(4-methyl-3-pentenyl)-3-cyclohexene carbaldehyde, 4-acetoxy-3-pentyl-tetrahydropyran, 3-carboxymethyl-2-pentyl-cyclopentane, 2-n-heptyl-cyclopentanone, 3-methyl-2-pentyl-2-cyclopentanone, n-decanal, n-dodecanal, dec-9-en-1-ol, phenoxy-ethyl isobyutyrate, phenylacetaldehyde dimethylacetal, phenyl-acetaldehyde diethylacetal, geranyl nitrile, citronellyl nitrile, cedryl acetate, 3-iso-camphyl cyclohexanol, cedrylmethyl ether, isolongifolanone, aubepine nitrile, aubepine, heliotropine, coumarin, eugenol, vanillin, diphenyl oxide, hydroxy citronellal, ionones, methyl ionones, isomethyl ionones, irones, cis-3-hexenol and esters thereof, indan musk fragrances, tetrain musk fragrances, isochroman musk frangrances, macrocyclic ketones, macrolactone musk fragrances, ethylene brassylate and aromatic nutri-musk frangrances.

In a particularly preferred embodiment of the present invention, the oxygen stable composition comprises one or more flavour or fragrance ingredients that are particularly sensitive to oxidation and that produce oxidation products with a pronounced undesirable flavour impact. Typical examples of such oxidation sensitive flavour and fragrance ingredients include limonene, citral and linalool. Consequently, in a preferred embodiment, the present composition contains limonene, citral and/or linalool as an active compound. These oxidation sensitive substances may be incorporated into the present composition as such, or they may be incorporated in the form of a natural extract or isolate. In a particularly preferred embodiment, these substances are introduced in to the present composition in the form of a citrus oil or a mint oil, most preferably in the form of a citrus oil.

The fragrance compositions according to the invention may be used successfully in perfumed articles. Examples of such perfumed articles are: soap, bath products, washing agents, dish washing and cleaning agents, pomanders, candles, cosmetics such as creams, ointments, body deodorant sticks and antiperspirant sticks.

Also pharmaceuticals and wash-active components which are prone to oxygen can be used as active compound to be encapsulated in the carbohydrate matrix according to the invention.

A major application of the invention is related to the field of flavours. In this respect it is noted that the final product according to the invention is capable of protecting and retaining 1 to 40 wt. % or even more, preferably 10 to 20 wt. % flavourant as active compound, depending on the type of flavourant and based on the total weight of the flavour. Examples of flavourants, in particular aromatic or volatile flavourants, to be encapsulated in the carbohydrate matrix according to the invention are for instance essential oils, like bergamot oil, citrus oil, e.g. lemon oil, orange oil, grapefruit oil and other volatile flavourants, like bakery and savoury flavourants as well as food flavourants such as strawberry, raspberry, kiwi, etc. Also other types of active compounds as indicated above can be encapsulated in the carbohydrate matrix according to the invention in an amount of 1-40 wt. % or more, preferably 10-20 wt. %, based on the total weight of the composition.

With respect to the weight ratio between the core particles and the carbohydrate coating it is brought to the fore that said ratio may vary considerably but preferably is in the range of 5.1 up to 1.5, most preferably about 1:1.

To the coated particle is then applied a further coating made of modified cellulose. For the purpose of the present invention, by “modified cellulose”, it is meant modified cellulose which can form thermally reversible gels. Preferred modified cellulose for use herein are selected from methyl cellulose, hydroxypropyl cellulose, hydroxypropyl methyl celulose, ethyl methyl cellulose, ethyl cellulose and mixture thereof.

The modified cellulose is typically present in an amount of from 1% to 20%, preferably from 1 to 5% by weight of the composition.

With respect to the weight ratio between the carbohydrate coating and the modified cellulose coating it is brought to the fore that said ratio may vary considerably but preferably is in the range of 5:1 up to 1:5, most preferably about 1:1.

The products according to the invention can be produced by any suitable process, according to which a coating containing the encapsulated active is fixed on inert core particles, for instance performed in a tumbler etc, thereafter followed by a further coating of modified cellulose. Most preferably, the products according to the invention are produced by means of a fluidised bed process.

Therefore, a further aspect of the invention is embodied by a process for producing the oxygen stable composition, comprising the steps of
a) forming an aqueous carbohydrate solution containing a carbohydrate mixture consisting of 5 to 95 wt. % high molecular weight film forming carbohydrate(s), 5 to 30 wt. % mono, di and trisaccharide(s), and 0 to 30 wt. % maltodextrin(s),
b) incorporating at least one active compound defined above into the solution of step (a),
c) introducing the aqueous solution of step (b) into a fluidised bed comprising inert core particles and using an inlet air temperature of 40-120° C., preferably 60-100° C., to obtain a core particle coated with the active compound encapsulated in a glassy state carbohydrate matrix; and
d) introducing after step (c) the modified cellulose as an aqueous solution with a concentration of 0.1-30 wt. % and preferably 2 -10 wt. % into the fluid bed comprising encapsulated active coated core particles and using an inlet air temperature of 40-120° C., preferably 60-100° C., to obtain a stable film onto the particles.
   By “glassy state”, it is meant a characteristic state associated with long chain molecules, such as polymers, whereby an amorphous solid is obtained whose behaviour resembles that of a glass.

More in general, the fluidised bed process may be carried out by spraying an emulsion of active compound and the carbohydrate matrix in water into a fluidised bed agglomerator, which has previously been charged with a quantity of inert core particles or with a sample of small encapsulates containing the carbohydrate matrix to be employed in a bulk preparation. The emulsion containing the carbohydrate matrix coats the inert core particles fluidised by the passage of air through the bed and causes some agglomeration of the particles and a build-up of the components of the emulsion including the carbohydrate matrix. Since the residence time in the fluidised bed is controllable, the spraying of the emulsion may be continued until the required particle size or active load has been obtained. Once obtained, the modified cellulose is introduced in the fluidised bed until the required level of said modified cellulose is deposited onto the surface.

In commercial practice, it is desirable to run the process as a continuous one, using equipment of appropriate size for the production required. Such continuous running tends to ensure the maximum uniformity of product. To achieve this, careful control of input spray rate, fluidisation air-flow rate and its temperature must be exercised.

The fluidised bed apparatus for use in this process can be selected from those of various manufacturers, including Aeromatic AG of Muttenz in Switzerland and “Strea-1” laboratory agglomerator, also supplied by Aeromatic AG. Other useful agglomerators are supplied by the Calmic Division of William Boulton of Burslem, England and by the firm Glatt, Binzen, Germany.

In a further embodiment of the invention, there are provided products comprising the invention composition or composition as prepared by the invention process. The present composition may suitably be applied in sugar confectionery articles as well as in savoury applications, e.g. dry soups, dry sauces, sausages, snacks and noodles Preferred products are sugar confectionery articles, more preferably selected from gum such as chewing gums, hard boiled sweets, marshmallows, chewing sweets, and mixtures thereof. Most preferably, the sugar confectionery article is chewing gum as the combination of oxygen stability and mechanical stability provided by the present particulate composition is especially appreciated in chewing gum applications.

Typically, the present composition will be incorporated in products in an amount within the range of at least 0.1 wt. %. Preferably the composition is incorporated in an amount of at least 0.3 wt. %, most preferably of at least 0.5 wt. %. The present composition may suitably be applied in a concentration of up to 90 wt. %. Preferably, the composition is applied in an amount that does not exceed 5 wt. %, more preferably an amount that does not exceed 3 wt. %. Because the present invention enables the manufacture an oxygen stable particulate composition that is essentially sugar free, said composition is advantageously employed in sugar free products, notably sugar free beverages and sugar free chewing gum.

A still further embodiment of the present invention relates to the use of a modified cellulose to improve the oxygen stability of one or more active compounds encapsulated in a matrix containing:

5 to 95 wt. % high molecular weight film forming carbohydrate;

5 to 30 wt. % mono, di and trisaccharides; and

0 to 30 wt. % maltodextrin

based on the total weight of the carbohydrate matrix; said use comprising coating the encapsulate with said modified cellulose. In a particularly preferred embodiment, the active compounds are selected from the group of limonene, citral, linalool and combinations thereof. Most preferably, the active compound is limonene.

In another preferred embodiment, the one or more active compounds are encapsulated in a matrix that is essentially sugar free.

The invention is illustrated in the following non-limiting example:

### EXAMPLE 1

The following formulation was prepared by dissolving or dispersing the components indicated below

500 g of a carbohydrate matrix consisting of 50 wt. % (250 g) Capsul®, 25 wt. %

(115 g) maltodextrin (DE 20) and 25 wt. % (125 g) sucrose being a carbohydrate matrix according to the invention

under stirring in 600 g water of 80° C. for 30 minutes. Then the mixture was cooled to 20° C. An orange flavourant (QL 06830) without any antioxidant preservative was added in an amount of 25 wt. % on total dry solids (166 g) under stirring and the prepared feed was homogenised using a Ultra Turrax T50 at 10,000 rpm for about 3 minutes. The homogenised feed (1266 g) was fed to a fluid bed GPCG01 laboratory agglomeration Wurster equipment with 700 g tea fannings fluidised, using a two fluid nozzle at 2 bar. Inlet air temperature was varied between 50° C. and 105° C., resulting in a variable product temperature between 38 and 55° C. The applied feed temperature was 30° C. and the air inlet flow was 120 m³/hr. An aqueous solution (750 g) containing 4 wt. % of Hydroxypropyl methylcellulose (Methocel E15) was prepared and was fed to the said fluid bed once the flavoured emulsion was completely sprayed onto the particle. The fluid bed operating conditions were chosen equal to that described in the previous step of coating the particles with a flavour emulsion.

1. An oxygen stable composition comprising inert core particles partially or completely coated with at least one active compound encapsulated in a carbohydrate matrix, wherein said carbohydrate matrix is comprised of:
5 to 95 wt. % high molecular weight film forming carbohydrate;
5 to 30 wt. % mono, di and trisaccharides; and
0 to 30 wt. % maltodextrin,
based on the total weight of the carbohydrate matrix, said coated particles being further coated with a modified cellulose having reversible gel formation properties upon temperature increase.

2. The composition according to claim 1, wherein the film forming carbohydrate is present in an amount of 45 to 70 wt. % based on the total weight of the carbohydrate matrix.

3. The composition according to claim 1, wherein the film forming carbohydrate is selected from the group consisting of gum arabic, gum acacia, lipophilically modified starches and mixtures thereof.

4. The composition according to claim 1, wherein the matrix contains 1-30 wt. % of a sweetener selected from the group consisting of sorbitol, mannitol, xylitol, hydrogenated starch hydrolysates, lactitol, maltitol, erythritol, hydrogenated isomaltulose, and combinations thereof.

5. The composition according to claim 4, wherein 100 wt. % of the mono, di and trisaccharide material is a sweetener selected from the group consisting of sorbitol, mannitol, xylitol, hydrogenated starch hydrolysates, lactitol, maltitol, erythritol, hydrogenated isomaltulose, and combinations thereof.

6. The composition according to claim 1 wherein the active compound encapsulated in the carbohydrate matrix is selected from the group consisting of flavourants, fragrances, pharmaceuticals and wash-active components.

7. The composition according to claim 6, wherein the active compound is selected from the group consisting of limonene, citral, linalool and combinations thereof.

8. The composition according to claim 1, wherein the encapsulated active compound is present in an amount of 1-40 wt. %, based on the total weight of the active compound containing carbohydrate matrix.

9. The composition according to claim 1, wherein the core particles are selected from the group consisting of tea fannings, tea dust, tobacco particles, acids, crystals of mono-, di- or trisaccharides, salt crystals, plant seeds, fibres, spray-dried particles and cellulose cells.

10. The composition according to claim 1, wherein the core particles coated with the carbohydrate matrix and modified cellulose additionally comprise an external coating comprising at least 50 wt. % lipids with a melting point of at least 30° C.

11. The composition according to claim 1, wherein the core particles coated with the carbohydrate matrix, the modified cellulose and optionally a fat layer have a size in the range of 0.1-3 mm.

12. The composition according to claim 1, wherein the weight ratio between the core particles and the carbohydrate matrix coating is from 5:1 to 1:5.

13. The composition according to claim 1, wherein the weight ratio between the carbohydrate matrix coating and the cellulose coating is from 5:1 to 1:5.

14. The composition according to claim 1, wherein the modified cellulose is selected from the group consisting of methyl cellulose, hydroxypropyl cellulose, hydroxypropyl methyl cellulose, ethyl methyl cellulose, ethyl cellulose and mixture thereof.

15. A process for producing an oxygen stable composition comprising the steps of
(a) forming an aqueous carbohydrate solution containing a carbohydrate mixture comprising 5 to 95 wt. % high molecular weight film forming carbohydrate(s), 5 to 30 wt. % mono, di and trisaccharide(s), and 0 to 30 wt. % maltodextrin(s);
(b) incorporating at least one active compound into the solution of step (a);
(c) introducing the aqueous solution of step (b) into a fluid bed comprising inert core particles and using an inlet air temperature of 40-120° C. to obtain a core particle coated with the active compound encapsulated in a carbohydrate matrix; and
(d) introducing after step (c) modified cellulose as an aqueous solution with a concentration of 0.1-30 wt. % and into the fluid bed comprising the encapsulated active coated core particles and using an inlet air temperature of 40-120° C. to deposit a stable film onto the particles.

16. A product comprising the oxygen stable composition obtainable according to the process of claim 15.

17. The product according to claim 16, wherein said product sugar confectionery articles.

18. The product according to claim 17, wherein the product is chewing gum.

19. The product according to claim 16, wherein said products are selected from the group consisting of dry soups, dry sauces, sausages, snacks and noodles.

20. The product according to claim 16, said product containing between 0.1 and 5.0 wt. % of the oxygen stable composition.

21. The product according to any one of claims 16-20, wherein the products are essentially sugar-free.

22. A method for improving the oxygen stability of one or more active compounds encapsulated in a matrix containing:
5 to 95 wt. % high molecular weight film forming carbohydrate;
5 to 30 wt. % mono, di and trisaccharides; and
0 to 30 wt. % maltodextrin based on the total weight of the carbohydrate matrix, said method comprising coating the encapsulate with a modified cellulose that has reversible gel formation properties upon temperature increase.
